(19) United States
(12) Patent Application Publication
(10) Pub. No.: US 2017/0044041 A1
(43) Pub. Date: Feb. 16, 2017

(54) GLASS FORMING APPARATUS AND METHODS OF FORMING A GLASS RIBBON

(71) Applicant: CORNING INCORPORATED, Corning, NY (US)

(72) Inventors: Hilary Tony GODARD, Duluth, MN (US); Scott Michael JAVIS, Ithaca, NY (US); Thomas Dale KETCHAM, Horseheads, NY (US); James Robert RUSTAD, Germantown, MD (US); Cameron Wayne TANNER, Horseheads, NY (US)

(21) Appl. No.: 15/039,252

(22) PCT Filed: Nov. 24, 2014
(86) PCT No.: PCT/US14/67037

§ 371 Date: May 25, 2016

Related U.S. Application Data
(60) Provisional application No. 61/909,064, filed on Nov. 26, 2013.

(51) Int. Cl. C03B 5/43; C04B 35/50; C03B 17/06

(52) U.S. Cl. CPC C03B 5/43; C03B 17/064; C04B 35/50; C04B 2235/447; C04B 2235/3224; C04B 2235/3229; C04B 2235/3227; C04B 2235/656; C04B 2235/786; C04B 2235/9669

(57) ABSTRACT

A glass forming apparatus comprises a forming device configured to form a glass ribbon from a quantity of molten glass. The glass forming apparatus includes a refractory material comprising monazite (REPO₄). In another example, a method of forming a glass ribbon with a glass forming apparatus includes the step of supporting a quantity of molten glass with a refractory member comprising a refractory material comprising monazite (REPO₄). The method further includes the step of forming the glass ribbon from the quantity of molten glass.

This application claims the benefit of priority under 35 U.S.C. §365 of International Patent Application Serial No. PCT/US14/67037 filed on Nov. 24, 2014, which claims benefit of priority to U.S. Provisional Application Ser. No. 61/909,064 filed on Nov. 26, 2013, the content of both are relied upon and incorporated herein by reference in their entirety.

### TECHNICAL FIELD

The present disclosure relates generally to glass forming apparatus and methods of forming a glass ribbon and, more particularly, to glass forming apparatus including a refractory material comprising monazite and methods of forming a glass ribbon including the step of supporting a quantity of molten glass with a refractory member comprising a refractory material comprising monazite.

### BACKGROUND

Glass forming apparatus are commonly used to form a glass ribbon from a quantity of molten glass. The glass ribbon may be used, for example, to produce various glass products such as LCD sheet glass.

### SUMMARY

The following presents a simplified summary of the disclosure in order to provide a basic understanding of some example aspects described in the detailed description.

In a first example aspect of the disclosure, a glass forming apparatus comprises a forming device configured to form a glass ribbon from a quantity of molten glass. The glass forming apparatus includes a refractory material comprising monazite (REPO₄).

In one example of the first aspect, the forming device includes the refractory material. In one instance, the refractory material comprises an outer layer of the forming device.

In another example of the first aspect, the glass forming apparatus further comprises a melting furnace configured to melt a quantity of material into the quantity of molten glass. A containment wall of the melting furnace includes the refractory material. In one instance, the refractory material comprises an inner layer of the containment wall that at least partially defines a containment area of the melting furnace.

In still another example of the first aspect, the refractory material comprises at least 50 volume percent of monazite (REPO₄), for example, at least 75 volume percent of monazite (REPO₄), for example, at least 90 volume percent of monazite (REPO₄).

In yet another example of the first aspect, the refractory material further comprises zircon (ZrSiO₄).

In a further example of the first aspect, the refractory material further comprises a xenotime type material. In one example, the xenotime type material comprises at least one element selected from the group consisting of: La, Ce, Pr, Nd, Sm, Eu, Gd, Tb, Dy, Ho, Er, Tm, Yb, Lu, Y and Sc.

In another example of the first aspect, RE comprises at least one element selected from the group consisting of: La, Ce, Pr, Nd, Sm, Eu, Gd, Tb, Dy, Ho, Er, Tm, Yb, Lu, Y and Sc. In one example, RE is a mixture of rare earth elements comprising La and at least one additional element selected from the group consisting of: Ce, Nd and Pr. In another example, RE is a mixture of rare earth elements comprising La and at least two additional elements selected from the group consisting of: Ce, Nd and Pr, such as a mixture of La, Ce, and Nd, a mixture of La, Ce, and Pr, or a mixture of La, Nd, and Pr. In another example, RE is a mixture of rare earth elements comprising La, Ce, Nd, and Pr. In another example, RE comprises at least 40 mole percent of La, such as at least 70 mole percent of La, including at least 70 mole percent of La, and at least one additional element selected from the group consisting of: Ce, Nd and Pr.

In another example, RE comprises at least 70 mole percent of La, such as at least 85 percent of La, and at least one additional element selected from the group consisting of: Nd, Y, and Pr. In another example, RE comprises at least 70 mole percent of La, and at least two additional elements selected from the group consisting of: Nd, Y, and Pr, such as a mixture of La, Nd, and Pr, a mixture of La, Nd, and Y, or a mixture of La, Pr, and Y. In another example RE comprises at least 70 mole percent La in combination with Nd, Pr, and Y. In any of the above examples wherein RE comprises at least 70 mole percent La, RE may comprise up to 30 mole percent of the at least one additional element selected from the group consisting of: Nd, Y, and Pr. For example, RE may comprise at least 85 percent La and up to 15 mole percent of at least one additional element selected from the group consisting of: Nd, Y, and Pr. When the at least one additional element includes Nd and Pr, the Pr to Nd atomic ratio can, for example, be from 0.1 to 0.4.

Exemplary embodiments include those in which RE comprises from 70 to 99 percent La and from 1 to 30 percent of at least one of Nd, Y, and Pr, such as where RE comprises from 85 to 99 percent La and from to 1 to 15 percent of at least one of Nd, Y, and Pr. For example, exemplary embodiments include those in which RE comprises from 70 to 99 percent of La, from 1 to 30 percent of Nd, from 0 to 10 percent of Y, and from 0 to 10 percent of Pr. Exemplary embodiments also include those in which RE comprises 70 to 99 percent of La, from 0 to 10 percent of Nd, from 1 to 30 percent of Y, and from 0 to 10 percent of Pr. Exemplary embodiments also include those in which RE comprises 70 to 98 percent of La, from 1 to 30 percent of Nd, from 0 to 10 percent of Y, and from 1 to 10 percent of Pr. Exemplary embodiments also include those in which RE comprises 70 to 97 percent of La, from 1 to 30 percent of Nd, from 1 to 10 percent of Y, and from 1 to 10 percent of Pr, Exemplary embodiments also include those in which RE comprises 70 to 97 percent of La, from 2 to 30 percent of Nd, from 0 to 10 percent of Y, and from 1 to 10 percent of Pr, wherein the ratio of Nd to Pr is at least 2:1. Exemplary embodiments also include those in which RE comprises 70 to 96 percent of La, from 2 to 30 percent of Nd, from 1 to 10 percent of Y, and from 1 to 10 percent of Pr, wherein the ratio of Nd to Pr is at least 2:1 and the ratio of Nd to Y is at least 2:1.

In yet another example of the first aspect, 0.95≦RE/P≦1.05, such as 0.97≦RE/P≦1.03.

Embodiments disclosed herein, including those disclosed above, include single phase monazite compositions.

In a further example of the first aspect, an average grain size of the monazite is greater than 5 microns and less than 200 microns.

In another example of the first aspect, the monazite has a creep rate described by any one of equations (1), (2) or (3):

creep rate=0.5×10²⁰×e^{(-89,120/T)} (1)

creep rate=0.333×10²⁰×e^{(-89,120/T)} (2)

creep rate=0.1×10²⁰×e^{(-89,120/T)} (3)

where T is the temperature (K) and T≧1453 K and creep rate has units of 1/hr when measured in flexure at 1,000 psi.

The first aspect may be provided alone or in combination with one or any combination of the examples of the first aspect discussed above.

In a second example aspect of the disclosure, a method of forming a glass ribbon with a glass forming apparatus is provided. The method includes the step of supporting a quantity of molten glass with a refractory member comprising a refractory material comprising monazite (REPO₄). The method further includes the step of forming the glass ribbon from the quantity of molten glass.

In one example of the second aspect, the refractory member comprises at least one of a containment wall and a forming device of the glass forming apparatus.

In another example of the second aspect, the refractory material comprises at least 50 volume percent of monazite (REPO₄).

The second aspect may be provided alone or in combination with one or any combination of the examples of the second aspect discussed above.

### BRIEF DESCRIPTION OF THE DRAWINGS

These and other aspects are better understood when the following detailed description is read with reference to the accompanying drawings, in which:

FIG. 1 is a schematic view of a glass forming apparatus including a forming device in accordance with aspects of the disclosure;

FIG. 2 is a cross-sectional enlarged perspective view of the forming device of FIG. 1;

FIG. 3 is an enlarged view of the forming device of FIG. 2 according to one embodiment of the disclosure.

FIG. 4 is an enlarged view of the forming device of FIG. 2 according to another embodiment of the disclosure.

FIG. 5 is a binary phase diagram for the Nd₂O₃—P₂O₅ system. (see M.-S. Wong and E. R. Kreidler, “Phase Equilibria in the System Nd₂O₃—P₂O₅, ” J. Am. Ceram. Soc., 70 [6] 396-399, 1987.)

FIG. 6 is a binary phase diagram for the La₂O₃—P₂O₅ system. (see H. D. Park and E. R. Kreidler, “Phase Equilibria in the System La₂O₃—P₂O₅,” J. Am. Ceram. Soc., 67 [1] 23-26, 1984.)

FIG. 7 is an X-ray diffraction (XRD) plot for NdPO₄+2 mol % Nd₂O₃ after sintering at 1500° C. for 4 hours in ambient atmosphere.

FIG. 8 is a scanning electron microscope (SEM) image of NdPO₄+2 mol % Nd₂O₃ of FIG. 7.

FIG. 9 is a SEM image of NdPO₄+2 mol % Nd₂O₃ after sintering at 1550° C. for 4 hours in ambient atmosphere.

FIG. 10 is a cross-sectional SEM image of an interface between NdPO₄+2 mol % Nd₂O₃ and glass sample E after isothermal reaction compatibility test between 1035 and 1235° C. for 72 hours in ambient atmosphere.

FIG. 11 is a cross-sectional SEM image of an interface between LaPO₄ and glass sample F after isothermal reaction compatibility test between 1100-1300° C. for 72 hours in ambient atmosphere.

FIG. 12 is a cross-sectional SEM image of an interface between (La_{0.73}Nd_{0.14}Ce_{0.10}Pr_{0.03})PO₄+4 mol % CeO₂ and glass sample H after isothermal reaction compatibility test between 1210 and 1410° C. for 72 hours in ambient atmosphere.

FIG. 13 is a cross-sectional SEM image of an interface between (La_{0.47}Nd_{0.23}Ce_{0.19}Pr_{0.11})PO₄ and glass sample A after isothermal reaction compatibility test between 1020 and 1220° C. for 72 hours in ambient atmosphere.

FIG. 14 is a cross-sectional SEM image and element analysis results by electron dispersive x-ray spectroscopy (EDX) of an interface between CePO₄ monazite and glass sample E after isothermal reaction compatibility test between 1035 and 1235° C. for 72 hours in ambient atmosphere.

FIG. 15 is a XRD plot for NdPO₄+10 mol % Nd₂O₃ after sintering at 1550° C. for 4 hours in ambient atmosphere.

FIG. 16 is a SEM image of NdPO₄+10 mol % Nd₂O₃ after sintering at 1550° C. for 4 hours in ambient atmosphere.

FIG. 17 is a cross-sectional SEM photograph of interface between NdPO₄+10 mol % Nd₂O₃ and glass sample F after isothermal reaction compatibility test between 1035 and 1235° C. for 72 hours in ambient atmosphere.

FIG. 18 is a cross-sectional SEM photograph of interface between NdPO₄+10 mol % Nd₂O₃ and glass sample H after isothermal reaction compatibility test 1210 and 1410° C. for 72 hours in ambient atmosphere.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

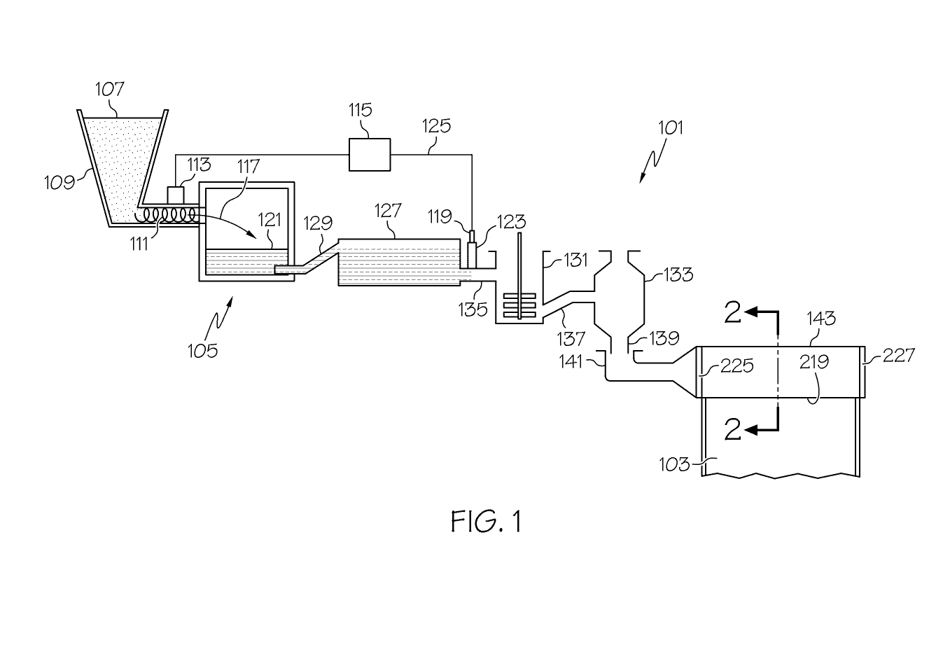

FIG. 1 illustrates a schematic view of a glass forming apparatus 101 for fusion drawing a glass ribbon 103 for subsequent processing into glass sheets. The illustrated glass forming apparatus comprises a fusion draw apparatus although other fusion forming apparatus may be provided in further examples. The glass forming apparatus 101 can include a melting vessel (or melting furnace) 105 configured to receive batch material 107 from a storage bin 109. The batch material 107 can be introduced by a batch delivery device 111 powered by a motor 113. An optional controller 115 can be configured to activate the motor 113 to introduce a desired amount of batch material 107 into the melting vessel 105, as indicated by an arrow 117. A glass metal probe 119 can be used to measure a glass melt (or molten glass) 121 level within a standpipe 123 and communicate the measured information to the controller 115 by way of a communication line 125.

The glass forming apparatus 101 can also include a fining vessel 127, such as a fining tube, located downstream from the melting vessel 105 and fluidly coupled to the melting vessel 105 by way of a first connecting tube 129. A mixing vessel 131, such as a stir chamber, can also be located downstream from the fining vessel 127 and a delivery vessel 133, such as a bowl, may be located downstream from the mixing vessel 131. As shown, a second connecting tube 135 can couple the fining vessel 127 to the mixing vessel 131 and a third connecting tube 137 can couple the mixing vessel 131 to the delivery vessel 133. As further illustrated, a downcomer 139 can be positioned to deliver glass melt 121 from the delivery vessel 133 to an inlet 141 of a forming device 143. As shown, the melting vessel 105, fining vessel 127, mixing vessel 131, delivery vessel 133, and forming device 143 are examples of glass melt stations that may be located in series along the glass forming apparatus 101.

The melting vessel 105 is typically made from a refractory material, such as refractory (e.g. ceramic) brick. The glass forming apparatus 101 may further include components that are typically made from platinum or platinum-containing metals such as platinum-rhodium, platinum-iridium and combinations thereof, but which may also comprise such refractory metals such as molybdenum, palladium, rhenium, tantalum, titanium, tungsten, ruthenium, osmium, zirconium, and alloys thereof and/or zirconium dioxide. The platinum-containing components can include one or more of the first connecting tube 129, the fining vessel 127 (e.g., finer tube), the second connecting tube 135, the standpipe 123, the mixing vessel 131 (e.g., a stir chamber), the third connecting tube 137, the delivery vessel 133 (e.g., a bowl), the downcomer 139 and the inlet 141. The forming device 143 is made from a ceramic material, such as the refractory, and is designed to form the glass ribbon 103.

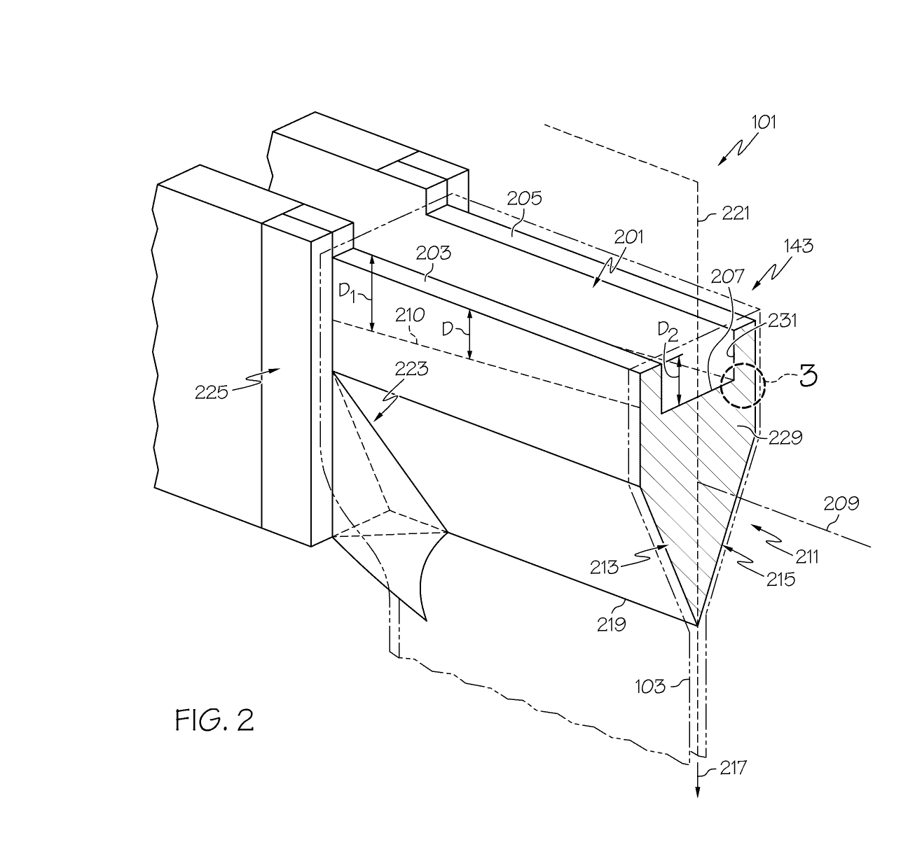

FIG. 2 is a cross-sectional perspective view of the glass forming apparatus 101 along line 2-2 of FIG. 1. As shown, the forming device 143 can include a trough 201 at least partially defined by a pair of weirs comprising a first weir 203 and a second weir 205 defining opposite sides of the trough 201. As further shown, the trough may also be at least partially defined by a bottom wall 207. As shown, the inner surfaces of the weirs 203, 205 and the bottom wall 207 define a substantially U shape that may be provided with round corners. In further examples, the U shape may have surfaces substantially 90° relative to one another. In still further examples, the trough may have a bottom surface defined by an intersection of the inner surfaces of the weirs 203, 205. For example, the trough may have a V-shaped profile. Although not shown, the trough can include further configurations in additional examples.

As shown, the trough 201 can have a depth “D” between a top of the weir and a lower portion of the trough 201 that varies along an axis 209 although the depth may be substantially the same along the axis 209. Varying the depth “D” of the trough 201 may facilitate consistency in glass ribbon thickness across the width of the glass ribbon 103. In just one example, as shown in FIG. 2, the depth “D₁” near the inlet of the forming device 143 can be greater than the depth “D₂” of the trough 201 at a location downstream from the inlet of the trough 201. As demonstrated by the dashed line 210, the bottom wall 207 may extend at an acute angle relative to the axis 209 to provide a substantially continuous reduction in depth along a length of the forming device 143 from the inlet end to the opposite end.

The forming device 143 further includes a forming wedge 211 comprising a pair of downwardly inclined forming surface portions 213, 215 extending between opposed ends of the forming wedge 211. The pair of downwardly inclined forming surface portions 213, 215 converge along a downstream direction 217 to form a root 219. A draw plane 221 extends through the root 219 wherein the glass ribbon 103 may be drawn in the downstream direction 217 along the draw plane 221. As shown, the draw plane 221 can bisect the root 219 although the draw plane 221 may extend at other orientations with respect to the root 219.

The forming device 143 may optionally be provided with one or more edge directors 223 intersecting with at least one of the pair of downwardly inclined forming surface portions 213, 215. In further examples, the one or more edge directors can intersect with both downwardly inclined forming surface portions 213, 215. In further examples, an edge director can be positioned at each of the opposed ends of the forming wedge 211 wherein an edge of the glass ribbon 103 is formed by molten glass flowing off the edge director. For instance, as shown in FIG. 2, the edge director 223 can be positioned at a first opposed end 225 and a second identical edge director (not shown in FIG. 2) can be positioned at a second opposed end (see 227 in FIG. 1). Each edge director 223 can be configured to intersect with both of the downwardly inclined forming surface portions 213, 215. Each edge director 223 can be substantially identical to one another although the edge directors may have different characteristics in further examples. Various forming wedge and edge director configurations may be used in accordance with aspects of the present disclosure. For example, aspects of the present disclosure may be used with forming wedges and edge director configurations disclosed in U.S. Pat. No. 3,451,798, U.S. Pat. No. 3,537,834, U.S. Pat. No. 7,409,839 and/or U.S. Provisional Pat. Application No. 61/155,669, filed Feb. 26, 2009 that are each herein incorporated by reference in its entirety.

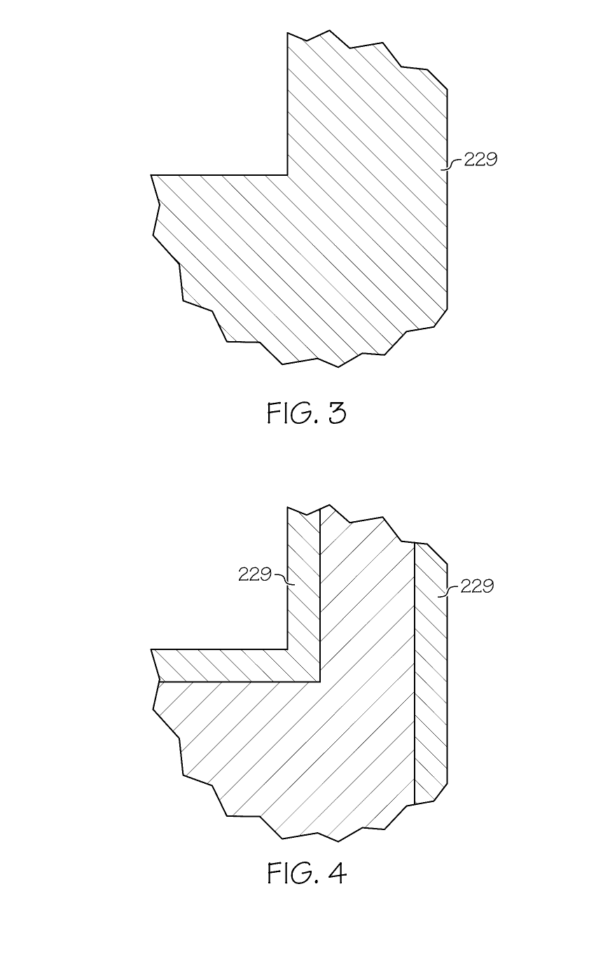

FIG. 3 is an exaggerated sectional perspective view of 3 of the forming device 143 of FIG. 2. As illustrated, the entire body of the forming device 143 can comprise the refractory 229. In another instance illustrated in FIG. 4, the forming device 143 can comprise the refractory 229 that is formed as an outer layer on the exterior of the forming device 143 such that the molten glass contacts only the refractory. For instance, the refractory 229 with a predetermined thickness can be formed on the outer side of the forming device 143.

The refractory material can comprise a wide range of ceramic compositions that have material properties that are suitable for fusion drawing molten glass into a glass ribbon. Typical material characteristics of the refractory material in the forming device can comprise resistance to high temperatures without contaminating the molten glass, strength, the ability to avoid creep, resistance to wear and/or other features. For example, xenotime (for example, YPO₄) can be one of the materials used for refractory materials in the glass forming apparatus including the forming device.

In this disclosure, the refractory material can comprise monazite (REPO₄). Monazite is broadly referred to as rare earth (RE) phosphate comprising one or more rare earth oxide and phosphorous oxide, and can comprise a crystal structure P2₁/n. The monazite can comprise PO₄ tetrahedra and REOₓ polyhedral. Y. Ni et al. “Crystal Chemistry of the Monazite and Xenotime Structures,” American Mineralogist, 80, 21-16, 1995. Monazite can additionally incorporate lanthanide group elements. Monazite can further incorporate scandium (Sc) and yttrium (Y) which are chemically similar to lanthanide group elements. The examples of rare earth elements that can form the monazite with phosphorous oxide can comprise at least one of La, Ce, Pr, Nd, Sm, Eu, Gd, Tb, Dy, Ho, Er, Tm, Yb, Lu, Y and Sc. It is noted that the monazite can comprise two or more rare earth elements, such as (La,Nd,Ce,Pr)PO₄.

Monazite can further incorporate ZrSiO₄ (zircon) into the monazite structure. Zircon can incorporate monazite into the zircon structure. Zircon has a tetragonal crystal structure, and can be dissolved into the monazite, where the amount of zircon dissolved into the monazite can depend on the sintering condition of the monazite and the particular combinations of rare earths in the monazite. The dissolved zircon can lower the activity of RE element located in the monazite, which, in turn, also lowers the reactivity of the refractory comprising the monazite. At least 25 mole percent of zircon can be dissolved into the monazite.

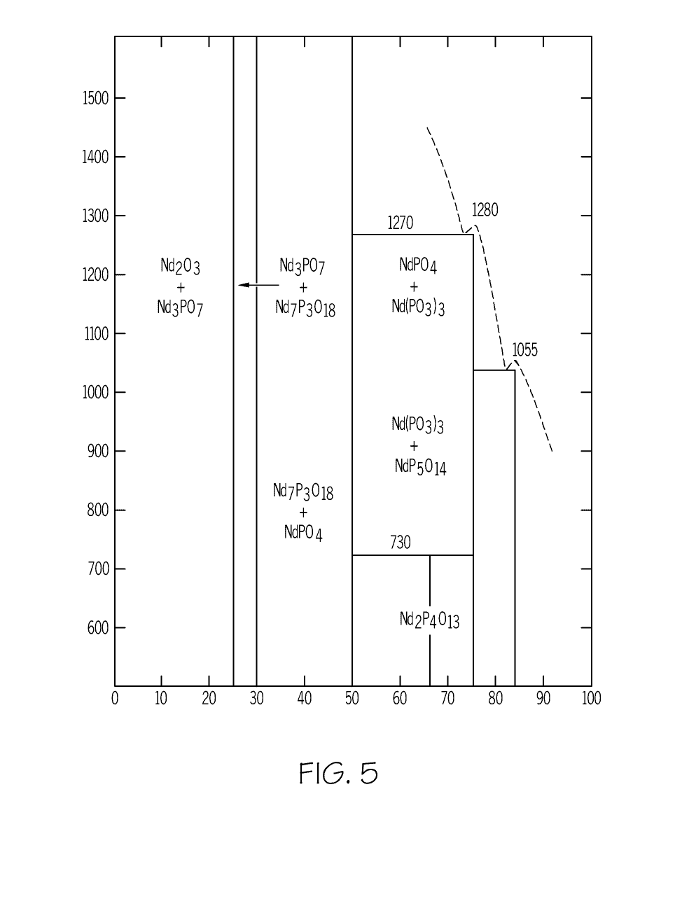

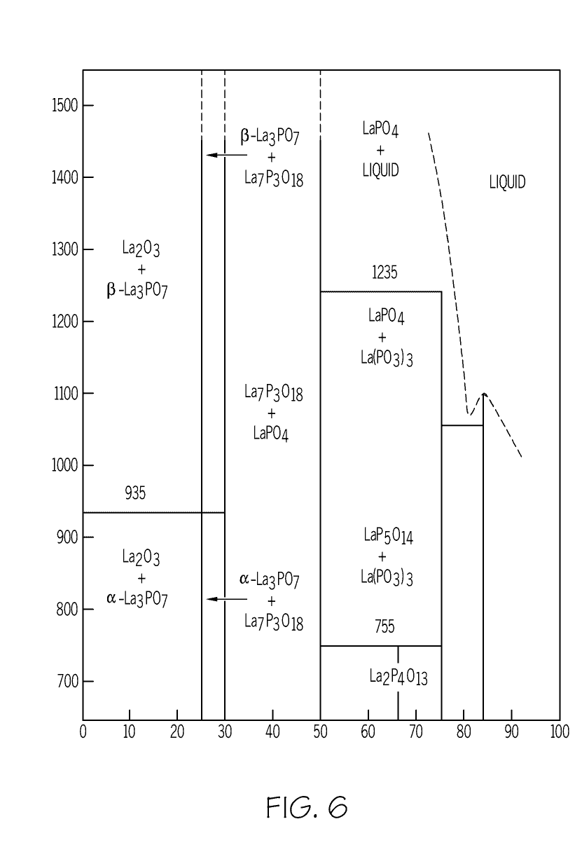

Examples of phase diagrams for the rare earth phosphate systems are given in FIGS. 5 and 6 to understand the phase development with composition and temperature. FIG. 5 illustrates a binary phase diagram for the Nd₂O₃—P₂O₅. The horizontal axis refers to the mol percent of phosphorous oxide (P₂O₅). The vertical axis refers to the temperature in the unit of degree Celsius (° C.). It appears that stoichiometric NdPO₄ does not melt at least up to 1500° C. Phase relations above 1500° C. are not completely understood. In the phosphorous rich region, the Nd(PO₃)₃ phase melts around 1270° C. Other numerous neodymium oxide-phosphorous oxide compounds can exist from room temperature up to at least 1500° C.

FIG. 6 illustrates a binary phase diagram for the La₂O₃—P₂O₅. The horizontal axis refers to the mol percent of phosphorous oxide (P₂O₅). The vertical axis refers to the temperature in the unit of degree Celsius (° C.). It appears that stoichiometric LaPO₄ does not dissociate at least up to 1550° C. Similar to Nd₂O₃—P₂O₅ binary system in FIG. 5, the deviation from the stoichiometry results in the formation of a plurality of secondary phases. For example, La₇P³O₁₈ or La₃PO₇ phase can be formed in the La rich region. La(PO₃)₃ or LaP₅O₁₄ phase, each of which appears to have lower melting temperature than pure stoichiometric LaPO₄, can be formed in the La deficiency region.

### Sample Preparation

Monazite refractories comprising the monazite can be prepared in the following steps. Phosphorous oxide (P₂O₅) and other rare earth oxides, such as Nd₂O₃, La₂O₃ or other oxides for forming the monazite, are weighed, thoroughly mixed and reacted at 1400° C. in platinum lined crucibles to form the monazite crystals. The formed monazite crystals are jet milled into a powder with an average particle size less than 5 microns. Some powder samples are pressed uniaxially and cold iso-statically, respectively, prior to further densification. Other powder samples are merely iso-statically pressed without uni-axial pressing. Regardless of the pressing steps, pressed samples are sintered for 4 hours at 1550-1650° C. for further densification. Xenotime (YPO₄) samples were also processed under identical processing conditions as other monazite refractories as a reference.

Table 1 shows that compositions and sintering conditions of monazites with different rare earth elements. It is noted the disclosure is not limited to the compositions disclosed in Table 1. For example, the disclosure can comprise orthophosphate monazite crystals comprising other rare earth elements not listed in Table 1. It is also understood that the monazite composition after sintering did not always match the batch composition. For example, for the batch mixed to have the composition of NdPO₄+2 mol % Nd₂O₃ batch, the final composition after sintering at high temperature was NdPO₄. As such, the actual stoichiometry may be slightly different from the batch composition, especially when combined with a variety of sintering conditions. As a result, as can be observed from the example of NdPO₄+2 mol % Nd₂O₃, it can be reasonably assumed that the actual composition of the monazite having stoichiometric batch composition can slightly be changed to satisfy RE/P≦1.00.

TABLE 1
Monazite Refractory Compositions

| Sample | Batch Composition | Firing condition (air) | Remarks |
|---|---|---|---|
| A | YPO₄ | 1750° C., 6-48 hours | Xenotime |
| B | NdPO₄ + 2 mol % Nd₂O₃ | 1500° C., 4 hours | |
| C | CePO₄ | 1400° C., 4 hours | |
| D | LaPO₄ | 1550° C., 4 hours | |
| E | NdPO₄ + 2 mol % Nd₂O₃ | 1550° C., 4 hours | Final: NdPO₄ |
| F | NdPO₄ + 2 mol % Nd₂O₃ | 1650° C., 4 hours | Final: NdPO₄ |
| G | CePO₄ | 1550° C., 4 hours | |
| H | CePO₄ | 1650° C., 4 hours | |
| I | (La_{0.73}Nd_{0.14}Ce_{0.10}Pr_{0.03})PO₄ + | 1550° C., 4 hours | |
| | 4 mol % CeO₂ | | |
| J | (La_{0.73}Nd_{0.14}Ce_{0.10}Pr_{0.03})PO₄ + | 1650° C., 4 hours | |
| | 4 mol % CeO₂ | | |
| K | (La_{0.47}Nd_{0.23}Ce_{0.19}Pr_{0.11})PO₄ | 1550° C., 4 hours | |
| L | (La_{0.47}Nd_{0.23}Ce_{0.19}Pr_{0.11})PO₄ | 1650° C., 4 hours | |
| M | LaPO₄ + 5 mol % La₂O₃ | 1550° C., 4 hours | Secondary phase |
| N | NdPO₄ + 10 mol % Nd₂O₃ | 1550° C., 4 hours | Secondary phase |
| O | NdPO₄ + 10 mol % Nd₂O₃ | 1650° C., 4 hours | Secondary phase |

Isothermal reaction compatibility tests were performed to investigate the physical and/or chemical reactions between the monazite and a plurality of glasses. The isothermal reaction compatibility tests were conducted in the following steps: a plurality of sintered monazite samples were placed in platinum (Pt) lined crucibles, and each sintered monazite sample was covered by a glass sample in the form of crushed glass cullet. The crucibles with the monazite samples covered by crushed glass cullet were held for 72 hours at predetermined testing temperatures, after which time, the crucibles were removed from the furnace. Monazite/glass samples were cut in cross-section, polished and examined by a scanning electron microscope (SEM) equipped with electron dispersive x-ray spectroscopy (EDX). Table 2 shows the glass compositions used in the isothermal reaction compatibility test. The glass samples in Table 2 can typically be used for special applications such as flat panel displays or portable communication devices.

TABLE 2
Glass Compositions for Isothermal Reaction Compatibility
Tests (by weight percent of components)

| | glass A | glass B | glass C | glass D | glass E | glass F | glass G | glass H | glass I |
|---|---|---|---|---|---|---|---|---|---|
| SiO₂ | 62.4 | 61.77 | 62.56 | 65.6 | 57.5 | 58.7 | 72 | 63.7 | 60.88 |
| Al₂O₃ | 17.22 | 16.25 | 19.2 | 13.75 | 21.3 | 21.4 | 9.4 | 18.9 | 16.80 |
| MgO | 1.4 | 3.58 | 1.68 | 4.11 | — | 1.45 | — | 2.17 | 2.22 |
| B₂O₃ | 10.5 | 0.65 | — | — | 7.27 | 5.4 | 7.8 | 0.62 | — |
| Na₂O | — | 13.25 | 13.9 | 13.35 | 12.95 | 12.83 | 8.6 | 0.01 | 13.95 |
| K₂O | — | 3.5 | — | 1.75 | 0.72 | — | 2.1 | — | — |
| CaO | 7.54 | 0.51 | 1.33 | 0.48 | — | — | — | 4.22 | 1.63 |
| SnO₂ | 0.19 | 0.49 | 0.21 | 0.46 | 0.23 | 0.19 | 0.2 | — | 023 |
| SrO | 0.8 | — | 1.12 | — | — | — | — | 1.83 | 1.42 |
| Fe₂O₃ | — | — | — | — | — | 0.075 | — | 0.02 | 0.02 |
| BaO | — | — | — | — | — | — | — | 8.27 | 0.02 |
| ZrO₂ | — | — | — | — | — | — | — | — | 2.83 |

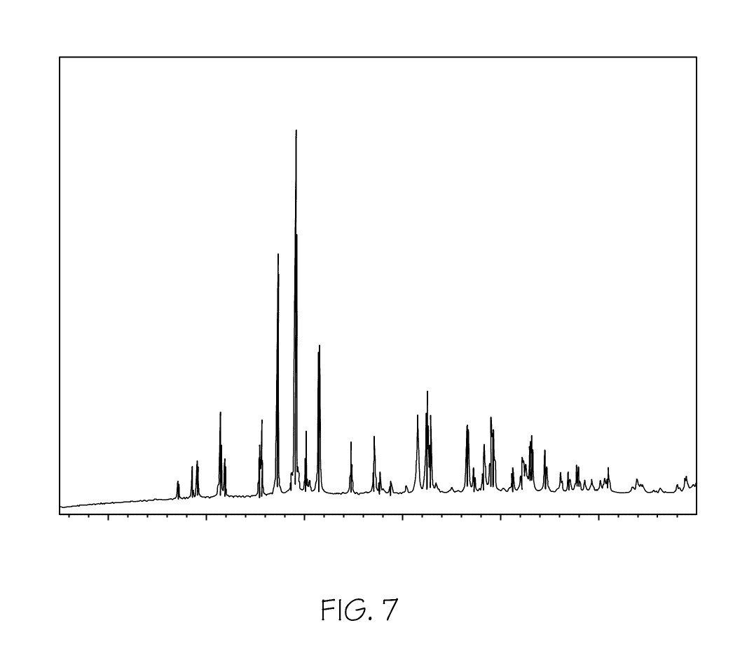

Phase distributions of the sintered monazites were examined by an x-ray diffraction (XRD). FIG. 7 illustrates an XRD pattern for a NdPO₄+2 mol % Nd₂O₃ sample sintered at 1500° C. for 4 hours in ambient atmosphere. The horizontal axis of FIG. 7 represents two theta angles while the vertical axis represents the relative intensity of x-ray reflected from the sample. Monazite crystal structure was confirmed by XRD analysis. While 2 mol % of Nd₂O₃ was incorporated into the stoichiometric NdPO₄ batch composition, no secondary phase was identified in the final sintered NdPO₄ within the measurement capability of XRD.

FIG. 8 illustrates a SEM image for the NdPO₄+2 mol % Nd₂O₃ of FIG. 7, which was sintered at 1500° C. for 4 hours in ambient atmosphere. The grain size of the sintered NdPO₄+2 mol % Nd₂O₃ sample was greater than 5 microns. For example, most grains had sizes of approximately 10 microns. The SEM image did not show that NdPO₄+2 mol % Nd₂O₃ had any signs of micro- or macro-cracking.

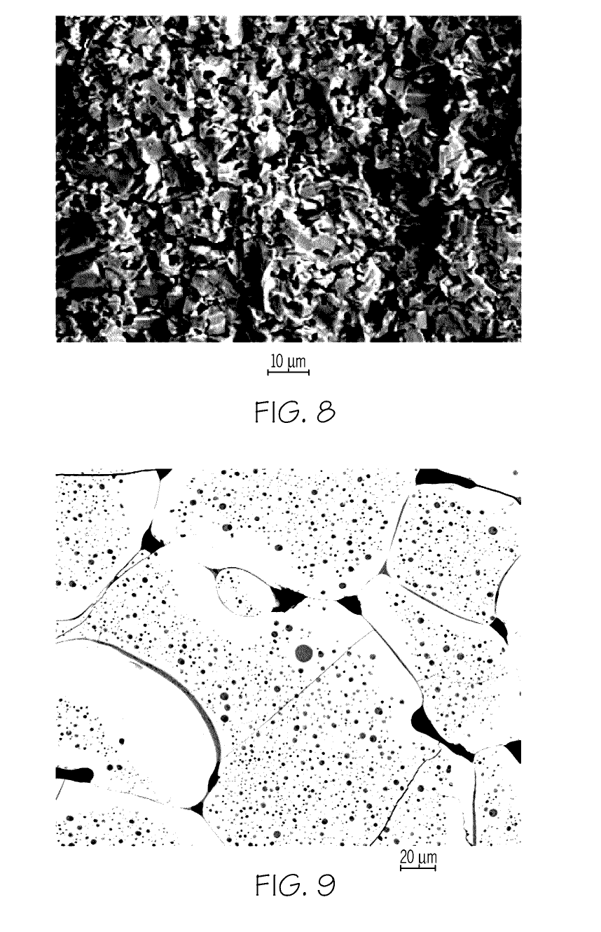

The effect of sintering conditions and a slight shift in Nd/P ratio on the microstructure of NdPO₄+“2 mol % Nd₂O₃” sample E is shown in FIG. 9. For this test, a different batch of NdPO₄+2 mol % Nd₂O₃ was made and was sintered at 1550° C., which is higher than the refractory sample in FIG. 8 by 50° C. It was found from XRD (not shown here) that although we intended to incorporate excess Nd₂O₃ into the stoichiometric NdPO₄ we actual made a Nd₂O₃ deficient composition that resulted in the formation of a secondary phase comprising NdP₃O₉, which is known to have a low melting temperature of about 1270° C., as shown in FIG. 5.

Above 1270° C., NdP₃O₉ can be in the liquid form, which acts as a flux during the liquid phase sintering, and the grain growth of NdPO₄ matrix is assisted by low temperature melting phase NdP₃O₉. The grain size of NdPO₄+“2 mol % Nd₂O₃” samples E and F can be greater than 50-100 microns, which is greater than NdPO₄+10 mol % Nd₂O₃ refractory by one order. For some NdPO₄+“2 mol % Nd₂O₃” grains, the grain size ranged from 150-200 microns. The grain size of the monazite is greater than 5 microns and less than 200 microns. Stated alternatively, the grain size can be any size between 5 microns and 200 microns. Samples E and F, NdPO₄+“2 mol % Nd₂O₃” also showed micro-cracks all over the samples, possibly due to the stress accumulated from the grain growth of NdPO₄ and thermal expansion anisotropy of monazite. Table 3 shows the reactivity of monazite and xenotime refractories reacted with different glass compositions. The isothermal reaction test was performed for 72 hours at a temperature ranging from 1000° C. to 1410° C. The isothermal reaction compatibility tests showed that both monazite and xenotime did not show any noticeable reactions with glass samples A and E.

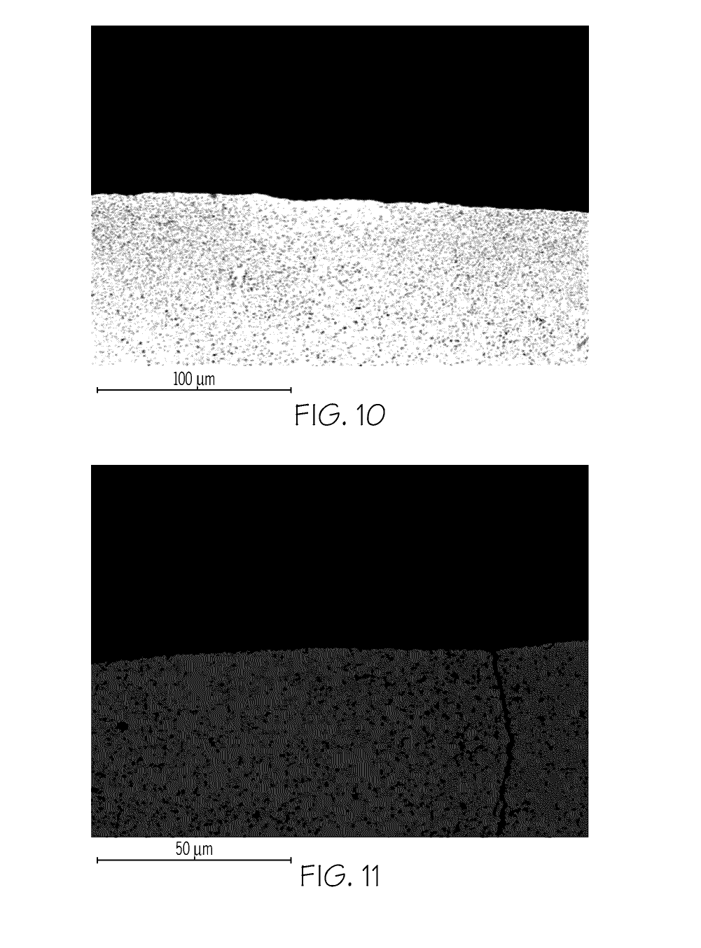

FIG. 10 is a cross-sectional SEM image of an interface between a NdPO₄+2 mol % Nd₂O₃ refractory and glass sample E after the isothermal reaction compatibility test between 1035 and 1235° C. for 72 hours in ambient atmosphere. No sign of an interface reaction between the refractory and glass sample E was observed.

It is understood that “no reaction” in this disclosure refers to a clean interface showing no chemical reaction between the monazite refractory and glass sample as confirmed by SEM image and element mapping analysis by EDX. For instance, no substantial amount of the components of glass sample and the refractory migrates in opposite direction during the isothermal reaction compatibility tests, and maintained the clean interface. In another instance, “no reaction” also refers to the interface where the one or more glass components physically impinge into the interior of the refractory without incurring chemical reactions.

However, “reaction” refers to the interface comprising the interface chemically whose chemical composition is different from at least one of the glass sample or refractory. In one instance, one or more glass components can react with one or more refractory components to form a layer chemically different from the composition in the glass sample or refractory. The layer can be crystallized, which can also be referred to as “secondary crystallization.” Yet in another instance, at least one component in the glass sample or refractory is segregated to form one or more precipitates from the glass-refractory interface.

In Table 3, for glass sample B, both monazite and xenotime showed reactivity with glass B. It appeared that the reaction products adhered to the surface of the refractories, respectively. It was also found that xenotime reacted with glass C, while monazite did not. Thus, it is believed that monazite has the potential to be used as the refractory in the forming device of glass manufacturing processes.

TABLE 3
Summary of isothermal reaction compatibility results at each temperature
for 72 hours

| | glass A | glass B | glass C | glass E |
|---|---|---|---|---|
| Monazite | No reaction | Reaction | No reaction | No reaction |
| (NdPO₄) | | | | |
| Xenotime (YPO₄) | No reaction | Reaction | Reaction | No reaction |
| Temperature (° C.) | two temps. | one temp. | two temps. | two temps. |
| | between 1000 | between 1050 | between 1100 | between 1000 |
| | and 1410 | and 1250 | and 1410 | and 1300 |
| Comment | | Reaction | Reaction | |
| Summary | | compound(s) | compound(s) | |
| | | look adherent | look adherent | |

### Lanthanum Phosphate (LaPO₄)

Stoichiometric LaPO₄ and LaPO₄+5 mol % La₂O₃ were selected to be reacted with a variety of glasses to determine whether lanthanum orthophosphate based monazites are suitable for refractories for the forming device. Tables 4 and 5 show the summaries of isothermal reaction compatibility tests for stoichiometric LaPO₄ and LaPO₄+5 mol % La₂O₃, respectively. For all glass samples used in the isothermal tests in Tables 4 and 5, both LaPO₄ and LaPO₄+5 mol % La₂O₃ refractories demonstrated very stable thermal stability with respect to a variety of glass samples.

For LaPO₄, no noticeable secondary crystallization phase was identified for any of the glass samples tested. For instance, FIG. 11 is a cross-sectional SEM image of an interface between LaPO₄ and glass sample F after isothermal reaction compatibility testing between 1100 and 1300° C. for 72 hours in ambient atmosphere. A clean interface was observed. For LaPO₄+5 mol % La₂O₃ refractory, no secondary reactions were observed for any glass sample, except for glass sample G, where LaPO₄+5 mol % La₂O₃ refractory formed a reaction layer from the refractory-glass interface. While it appears that LaPO₄ refractory may be more versatile than LaPO₄+5 mol % La₂O₃ in holding a variety of molten glass compositions in the forming device without any secondary crystallization, it is also believed that both LaPO₄ and LaPO₄+5 mol % La₂O₃ refractories can be used for the forming device. It is noted that LaPO₄+5 mol % La₂O₃ refractories satisfy the relation of 0.95≦RE/P≦1.05. Stated alternatively, the RE to P ratio can be such that RE is present up to a 5 mol % excess compared to P, such as 1 mol %, 2 mol %, 3 mol %, 4 mol % or 5 mol % excess. In another aspect, the RE/P ratio can be such that RE is present up to 5 mol % deficiency compared to P, such as 5 mol %, 4 mol %, 3 mol %, 2 mol % or 1 mol % deficient.

TABLE 4
Summary of isothermal reaction compatibility tests for LaPO₄

| Temperature | Time | | |
|---|---|---|---|
| (° C.) | (hours) | Glass samples | Results |
| two temps. between 1000 | 72 | glass A | No secondary crystallization |
| and 1410 | | | |
| two temps. between 1000 | 72 | glass E | No secondary crystallization |
| and 1300 | | | |
| two temps. between 1000 | 72 | glass F | No secondary crystallization |
| and 1350 | | | |
| one temp. between 1180-1380 | 72 | glass G | No secondary crystallization |
| one temp between 1210 | 72 | glass H | No secondary crystallization |
| and 1410 | | | |

TABLE 5
Summary of isothermal reaction compatibility tests for
LaPO₄ + 5 mol % La₂O₃

| Temperature | Time | Glass | |
|---|---|---|---|
| (° C.) | (hours) | samples | Results |
| one temp. between | 72 | glass A | No secondary crystallization |
| 1020 and 1220 | | | |
| one temp between | 72 | glass E | No secondary crystallization |
| 1000 and 1200 | | | |
| one temp. between | 72 | glass F | No secondary crystallization |
| 1000 and 1200 | | | Glass penetration with |
| | | | dissolution of secondary |
| | | | refractory phase |
| one temp. between | 72 | glass G | Microstructural change |
| 1180 and 1380 | | | s and reaction layer |
| one temp. between | 72 | glass H | No secondary crystallization |
| 1210 and 1410 | | | Some glass infiltration |

The effect of the rare earth element lanthanum (La) on the isothermal reaction compatibility tests was further investigated. For this, monazite refractory compositions were selected such that the selected compositions comprised different amounts of La as the rare earth element. In addition to La, a predetermined amount of at least one of cerium (Ce), neodymium (Nd) and praseodymium (Pr) were also weighed, thoroughly mixed together, and sintered for densification as described in the sample preparation. Two La monazite compositions were selected: (1) (La_{0.73}Nd_{0.14}Ce_{0.10}Pr_{0.03})PO₄+4 mol % CeO₂ (referred to as “high La” monazite) and (2) (La_{0.47}Nd_{0.23}Ce_{0.19}Pr_{0.11})PO₄ (referred to as “low La” monazite).

Table 6 shows the results of isothermal reaction compatibility testing for high La and low La monazite refractories reacted with a variety of glass samples. Regardless of glass compositions reacted with refractories, neither high La nor low La monazite refractories showed any noticeable chemical reaction at the interface between the refractory and glass sample. As such, for glass samples A, E, F, G and H selected for this test, the monazite refractories did not show any secondary crystallization after 72 hours as examined by SEM. EDX probing also did not demonstrate any signs of interfacial reaction. It is believed that, similar to the LaPO₄ monazite refractory investigated above, the introduction of La in the orthophosphate monazite improved chemical durability of monazite refractory against a variety of glass samples.

TABLE 6
Isothermal reaction compatibility test results for monazites comprising La
and at least one of Ce, Nd and Pr

| | | Time | Glass | |
|---|---|---|---|---|
| Refractories | Temperature (° C.) | (hours) | samples | Results |
| Low La | One temps. between | 72 | glass F | No secondary crystallization |
| | 1150 and 1350 | | | |
| Low La | two temps. between | 72 | glass E | No secondary crystallization |
| | 1000 and 1300 | | | |
| Low La | two temps. between | 72 | glass A | No secondary crystallization |
| | 1000 and 1410 | | | |
| Low La | one temp. between | 72 | glass G | No secondary crystallization |
| | 1180 and 1380 | | | |
| Low La | one temp. between | 72 | glass H | No secondary crystallization |
| | 1210 and 1410 | | | |
| High La | one temp. between | 72 | glass F | No secondary crystallization |
| | 1100 and 1300 | | | |
| High La | two temps. between | 72 | glass E | No secondary crystallization |
| | 1000 and 1300 | | | |
| High La | two temps. between | 72 | glass A | No secondary crystallization |
| | 1000 and 1410 | | | |
| High La | one temp. between | 72 | glass G | No secondary crystallization |
| | 1180 and 1380 | | | |
| High La | one temp. between | 72 | glass H | No secondary crystallization |
| | 1210 and 1410 | | | |

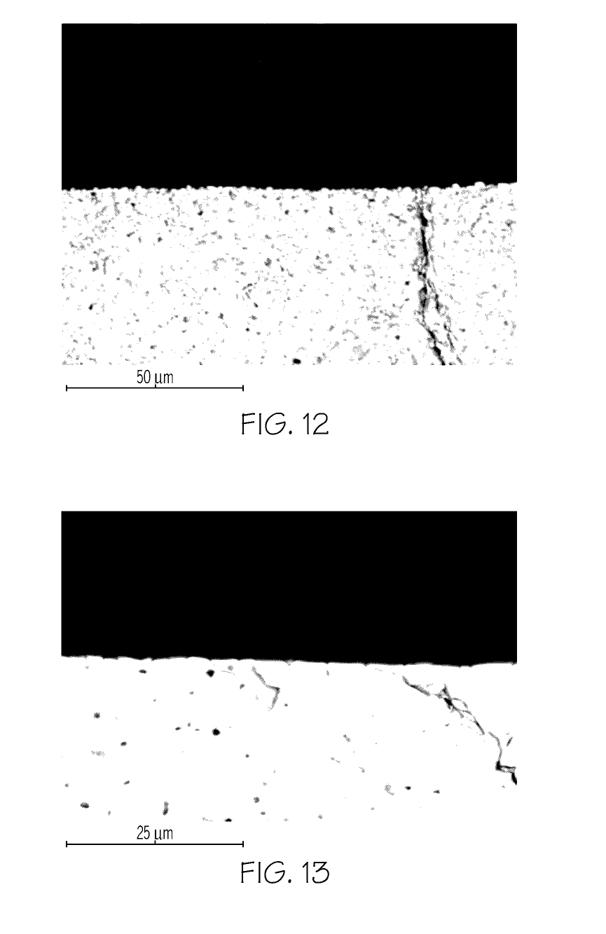

FIG. 12 shows a cross-sectional SEM image of interface between (La0.73Nd_{0.14}Ce0.10Pr_{0.03})PO₄+4 mol % CeO₂ refractory and glass sample H after isothermal reaction compatibility testing between 1210 and 1410° C. The SEM image shows a clear interface between the glass sample and the refractory. No sign of an interfacial reaction was detected by the elemental analysis by EDX.

FIG. 13 is a cross-sectional SEM image of an interface between (La_{0.47}Nd_{0.23}Ce_{0.19}Pr_{0.11})PO₄ and glass sample A after isothermal reaction compatibility test between 1020 and 1220° C. for 72 hours. Similar to the high La monazite, the interface between the low La monazite and glass sample A did not show any sign of an interfacial reaction.

From Table 6, it is not clear whether which one of the high La and low La refractories is more effective in suppressing any chemical reaction at the interface. It is believed that even a relatively low La monazite comprising 47 mol % of rare earth elements was found to be effective in precluding the interfacial chemical reaction with a variety of glasses during the high temperature reaction, as well as the high La (73 mol % of rare earth elements) monazite. Considering the chemical stability of glass samples reacted with high La and low La refractories across the broad temperature ranges in the isothermal tests in Table 6, the monazite refractories comprising at least 40 mol % of La are exemplary candidates as the refractory material for certain components of the glass manufacturing apparatus, including at least the melting furnace and the forming device.

### Cerium Phosphate (CePO₄)

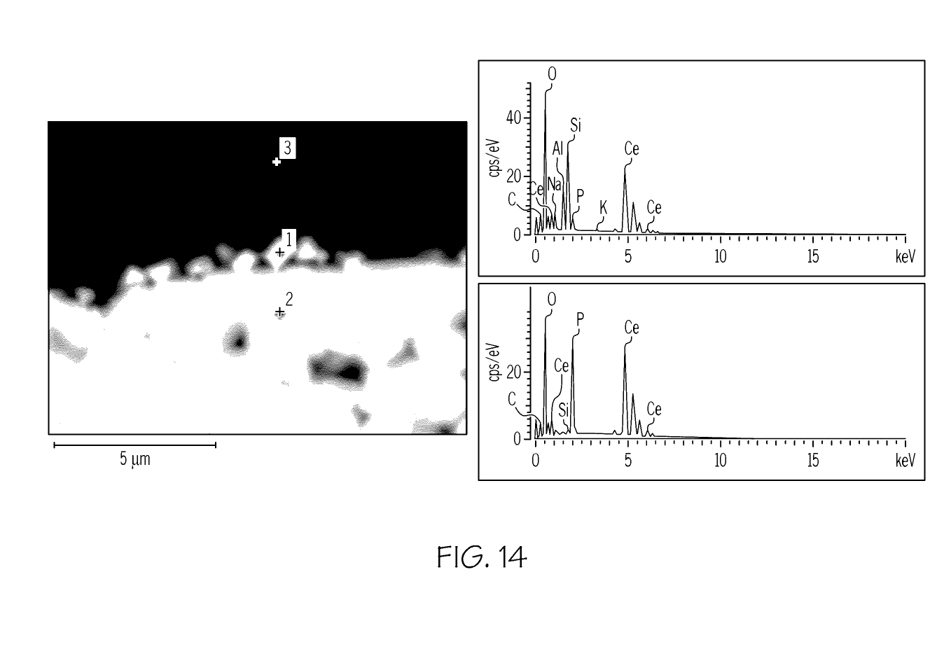

CePO₄ monazite refractories were formed into pellets, and sintered for densification, as described in sample preparation. Sintered CePO₄ were reacted with selected glass samples, such as glass sample A, E, F, G and H, for the isothermal reaction compatibility tests at predetermined temperatures for 72 hours, the results shown in Table 7. CePO₄ was found to be chemically stable with glass samples A, G, and H during the isothermal reaction compatibility tests. Clean interfaces were confirmed with SEM and EDX. CePO₄ showed a limited degree of reactivity with glass samples E and F. As shown in FIG. 14, a sub-micron sized secondary phase was detected at the interface between CePO₄ and glass sample E after isothermal test between 1035 and 1235° C. EDX mapping results showed that the intensity of Ceria detected at spot 1 (which is Ceria containing secondary phase) is substantially identical to that detected at spot 2, which is the bulk of CePO₄ refractory. It appears that the secondary phase comprising mostly Ceria is dissolved from CePO₄ refractory possibly from the reaction with glass sample E, then discretely precipitated at the interface. Ceria containing secondary phase was also detected at the interface between CePO₄ and glass sample F reacted at between 1100 and 1300° C. for 72 hours.

TABLE 7
Summary of isothermal reaction compatibility tests for
monazite CePO₄

| Temperature | Time | Glass | |
|---|---|---|---|
| (° C.) | (hours) | samples | Results |
| two temps. between | 72 | glass A | No secondary crystallization |
| 1000 and 1410 | | | |
| one temp. between | 72 | glass G | No secondary crystallization |
| 1180 and 1380 | | | |
| one temp. between | 72 | glass H | No secondary crystallization |
| 1210 and 1410 | | | |
| two temps. between | 72 | glass E | Cerium containing phase on |
| 1000 and 1300 | | | interface |
| two temps. between | 72 | glass F | Cerium containing phase on |
| 1000 and 1300 | | | interface |

### NdPO₄ Monazite and NdPO₄+10 mol % Nd₂O₃ Monazite

While stoichiometric monazite can be designed for the refractory in the forming device, the actual compositions of monazite do not have to be stoichiometric. For instance, depending on the processing conditions of monazite, such as the weighing of starting precursor, the sintering temperature, or the sintering atmosphere, the actual monazite composition can be different from the batch composition. In this case, the excess (or deficiency) from stoichiometry can result in the formation of one or more additional secondary phases, which can co-exist with the stoichiometric monazite phase. The nucleation and/or growth behavior of the secondary phase(s) can affect the micro or macro structural, mechanical, chemical and/or electrical properties of monazite.

A NdPO₄-based monazite composition was selected for investigating the effect of excess rare earth elements on the phase development, microstructure and chemical durability with a variety of glass samples at elevated temperatures. For isothermal reaction tests, 2 mol % Nd₂O₃ and 10 mol % Nd₂O₃ were incorporated into the stoichiometric NdPO₄ batches to form NdPO₄+2 mol % Nd₂O₃ and NdPO₄+10 mol % Nd₂O₃, respectively.

During the sintering of multi-component ceramics, a low temperature melting phase and a high temperature melting phase can develop. Without wishing to be bound by theory, it is believed that above a predetermined temperature, the low temperature melting phase can initiate a liquid phase sintering, where the mass transfer of the low temperature melting phase can be typically accelerated. The accelerated mass transfer can also affect the nucleation and grain growth of the high temperature melting phase. For example, the grain growth of the high temperature melting phase is also expedited with the assistance of the mass transfer. As a result, the overall grain size of the multi-component ceramics can be larger than that of the ceramics that does not comprise any low temperature melting phase. The average grain size and other microstructural properties of the multi-component ceramic can be determined by a plurality of parameters such as the degree of deviation from the stoichiometry, sintering temperature, sintering time, sintering atmosphere or the like.

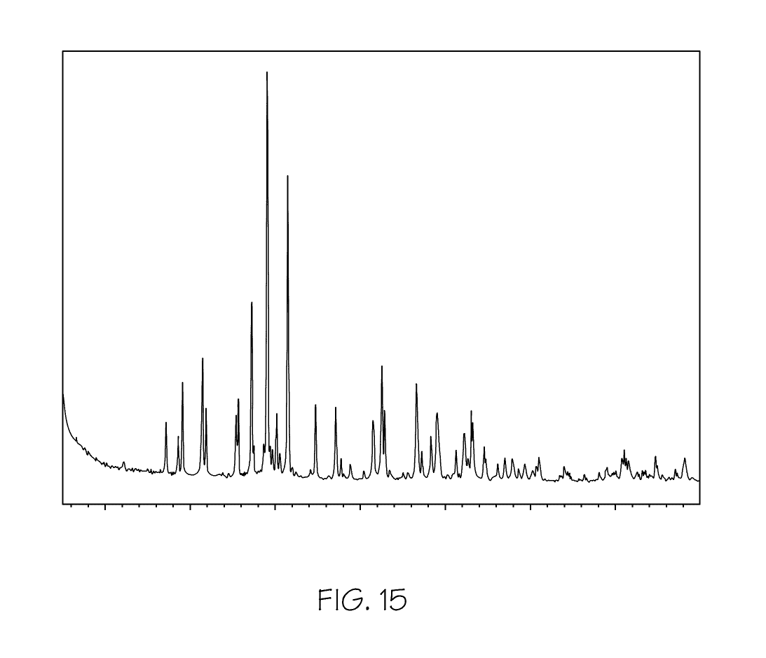

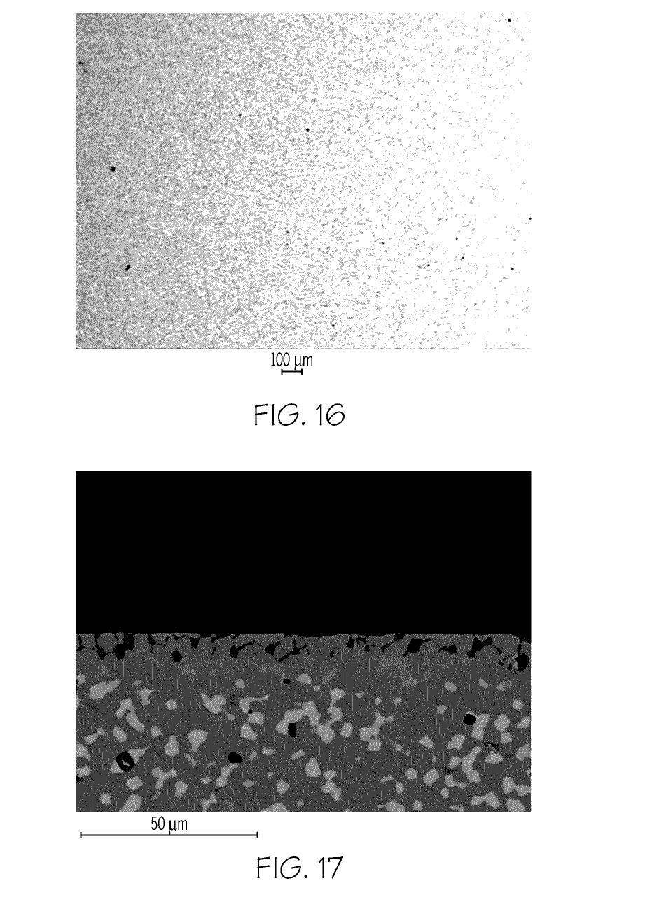

FIGS. 15 and 16 illustrate an XRD pattern and SEM image, respectively, of NdPO₄+10 mol % Nd₂O₃ refractory sintered at 1550° C. for 4 hours in ambient atmosphere. The horizontal axis of FIG. 15 represents two theta angles while the vertical axis represents the relative intensity of x-ray reflected from the sample. Monazite crystal structure was confirmed as the major phase by the XRD. In addition to NdPO₄ monazite, Nd₃PO₇ was also identified as a secondary phase in the XRD pattern.

The SEM image further revealed that overall microstructure of NdPO₄+10 mol % Nd₂O₃ refractory had crack-free structure, with uniform phase and pore distribution. A NdPO₄ major phase was found to have a grain size below about 10-15 microns, with the secondary phase of Nd₃PO₇ having a smaller grain size than the major NdPO₄ phase. It is understood that Nd₇P₃O₁₈ can co-exist with Nd₃PO₇ as a secondary phase.

NdPO₄+10 mol % Nd₂O₃ refractories prepared as described above in sample preparation were reacted with a variety of glass samples at 1000 to 1410° C. for 72 hours. Table 8 shows the summary of the isothermal reaction compatibility tests. After isothermal reaction tests, it was observed that refractories were chemically stable for some glass samples, while chemical reactions were observed for other glass samples. For example, refractories did not show any secondary crystallization initiated from the refractory-glass interface for glass samples A, E, and F. Yet for glass sample F, it appeared that the molten glass penetrated into the refractory during the isothermal reaction test, and dissolved the secondary phase that was already formed in the refractory. However, the dissolution of the secondary phase in refractory did not lead to the further crystallization, which strongly suggests that refractory can still be used for holding molten glass comprising glass sample F in the forming device or melting furnace of the glass forming apparatus.

A cross-sectional SEM image of the interface between NdPO₄+10 mol % Nd₂O₃ refractory and glass sample F after isothermal reaction compatibility test between 1000 and 1200° C. for 72 hours is shown in FIG. 17. The SEM image shows that the secondary phase Nd₃PO₇, which was already present in the sintered NdPO₄+10 mol % Nd₂O₃ refractory, reacted with glass sample F at the glass-refractory interface. While the elements of the glass sample F appear to be mixed with the refractory comprising Nd₃PO₇, it appears that noticeable crystallization of the secondary phase did not occur at the refractory-glass interface.

In Table 8, a NdPO₄+10 mol % Nd₂O₃ refractory was found to actively react with glass samples G and H, respectively. For example, after 72 hours of isothermal reaction tests, the secondary phase in the refractory reacted with glass sample G from the refractory-glass interface to form a reaction phase, which formed at the refractory-glass interface, then propagated toward the interior of glass sample G.

TABLE 8
Summary of isothermal reaction compatibility tests for
NdPO₄ + 10 mol % Nd₂O₃

| Temperature | Time | Glass | |
|---|---|---|---|
| (° C.) | (hours) | samples | Results |
| two temps. between | 72 | glass A | No secondary crystallization |
| 1000 and 1410 | | | |
| two temps. between | 72 | glass E | No secondary crystallization |
| 1000 and 1300 | | | |
| one temp. between | 72 | glass F | No secondary crystallization |
| 1000 and 1200 | | | Glass penetration with |
| | | | dissolution of secondary |
| | | | refractory phase |
| one temp. between | 72 | glass G | Microstructural changes and |
| 1180 and 1380 | | | reaction layer |
| one temp. between | 72 | glass H | No secondary crystallization |
| 1210 and 1410 | | | Microstructural changes and |
| | | | reaction layer |

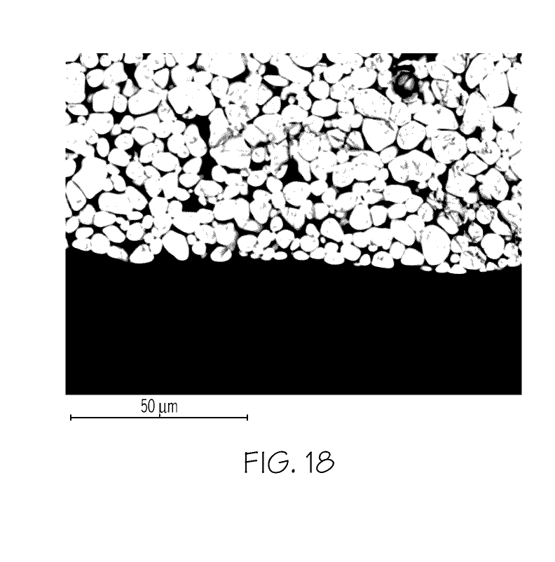

The cross-sectional SEM image of the interface between the refractory and the glass sample H after the isothermal reaction test at between 1210 and 1410° C. for 72 hours is shown in FIG. 18. The SEM image illustrates that the secondary phase already present in the refractory can initiate reaction with glass sample H at the glass-refractory interface. It appears that, during the isothermal reaction, the secondary phase, such as Nd₃PO₇ or Nd₇P₃O₁₈, reacts with the glass sample H at the glass-refractory interface, and further moves inward toward the interior of the glass sample H, to have a third phase which precipitates in the interior of the glass sample H.

### ADDITIONAL EXAMPLES

Table 9 lists compositions and sintering temperatures for various refractory materials with the major phase being of a monazite crystal structure. X-ray diffraction showed raw materials of La₂O₃, Nd₂O₃ to have detectable amounts of hydroxides and that “Pr₂O₃” was actually primarily Pr₆O₁₁ and detectible amount of PrO₂. The loss on ignition up to 800° C. of rare earth oxides/hydroxides, La₂O₃, Y₂O₃, Nd₂O₃, and Pr₆O₁₁ with (detectible amount of PrO₂) was measured. Accounting for the loss on ignition and the Pr₆O₁₁+PrO₂ combination, appropriate masses of rare earth oxides (+hydroxides) were turbula mixed with dry P₂O₅, dried overnight at 125° C. and then reacted at 1400° C. in platinum lined crucibles to synthesize the monazite materials. The synthesized monazites where jet milled into powder with an average particle size below 5 microns. For samples I and j after the monazite powder was made, additional La₂O₃ (j) or Y₂O₃ (i) was added and the mixture turbula mixed.

The samples where either uni-axially pressed in a steel die, then cold iso-statically pressed in a polymer bag at 18 Kpsi, or simply filled into a polymer bag and cold pressed at 18 Kpsi. The majority of the samples were made as disks of less than 3 inch diameter and less than 1 inch thick (before cold iso- pressing and sintering) or pellets of less than 1.5 inch diameter and 1 inch thick. The sintering schedule for these was simple, 24 hrs. from room temperature to the sintering temperature, 4 hour hold and then 12 hours to room temperature. Bars of 1 inch square cross-section and ˜8 inches long were also made using 60-70 hours to reach the sintering temperature, 4 hour hold and then 12 hours to room temperature. Samples with closed porosity were produced.

TABLE 9
Additional Refractory Compositions

| | | | RE/P |
|---|---|---|---|
| | | Firing condition | atomic |
| Sample | Batch Composition | (air) | ratio |
| P | (La_{0.925}Y_{0.05})PO₄ | 1738° C., 24 hours | 0.975 |
| Q | (La_{0.780}Y_{0.20})PO₄ | 1750° C., 16 hours | 0.980 |
| R | (La_{0.833}Nd_{0.147})PO₄ | 1750° C., 4 hours | 0.980 |
| S | (La_{0.683}Nd_{0.294})PO₄ | 1750° C., 64 hours | 0.977 |
| T | (Y_{1.08})PO₄ | 1650° C., 64 hours | 1.08 |
| U | (La_{0.987})PO₄ | 1600-1700° C., 4 | 0.987 |
| | | hours | |
| V | (La_{1.022})PO₄ | 1600-1700° C., 4 | 1.022 |
| | | hours | |
| W | (La_{0.828}Nd_{0.1105}Pr_{0.036})PO₄ | 1750° C., 4 hours | 0.975 |
| X | (La_{0.780}Nd_{0.147}Pr_{0.048}Y_{0.03})PO₄ | 1750° C., 4 hours | 1.005 |
| Y | (La_{0.898}Nd_{0.1105}Pr_{0.036})PO₄ | 1750° C., 4 hours | 1.045 |

Samples of several Monazite compositions set forth in Table 9 and one Xenotime composition, sample T, Table 9, were tested against glass A from Table 2 as well as glasses J and K from Table 10 at the times and temperature ranges indicated in Table 11.

TABLE 10
Glass Compositions for Additional Isothermal Reaction
Compatibility Tests (by weight percent of components)

| | Glass J | Glass K |
|---|---|---|
| SiO₂ | 62.52 | 54.36 |
| Al₂O₃ | 18.51 | 21.29 |
| MgO | 2.07 | 2.34 |
| B₂O₃ | 2.60 | — |
| Na₂O | — | 0.09 |
| K₂O | — | — |
| CaO | 4.24 | 4.78 |
| SnO₂ | 0.22 | 0.21 |
| SrO | 2.12 | 2.39 |
| Fe₂O₃ | 0.02 | 0.02 |
| BaO | 7.65 | 8.64 |
| P₂O₅ | — | 5.87 |
| TiO₂ | — | 0.01 |

As can be seen from Table 11, a few reaction products were observed for some glasses, temperatures and sample compositions. Most monazite refractory/isopipe compositions did not react with the glasses. “Quench” tests were also performed where the refractory and glass where held at a high temperature for 72 hours, the furnace rapidly cooled to a lower temperature then held for an additional 72 hours. The glass refractory interface was examined by SEM and EDAX (energy dispersive X-ray spectroscopy).

TABLE 11
Summary of Additional Isothermal Reaction Compatibility Tests

| Re- | | | Temper- | |
|---|---|---|---|---|
| fractory | Glass | Time | ature | |
| Sample | Sample | (hours) | (° C.) | Results |
| P | A | 72 | 1100-1300 | No reaction detected |
| P | A | 72 | 1100-1300 | No reaction detected |
| P | A | 72 + 72 | 1100-1300 | No reaction detected |
| | | quench | | |
| P | A | 72 + 72 | 1100-1300 | No reaction detected |
| | | quench | | |
| Q | A | 72 | 1100-1300 | Possible Y diminishment of |
| | | | | contact refractory |
| Q | A | 72 | 1100-1300 | Zones of altered microstructure |
| | | | | near interface that appear |
| | | | | recrystallized and not |
| | | | | interconnected |
| Q | A | 72 + 72 | 1100-1300 | Possible Y diminishment of |
| | | quench | | contact refractory with 5 |
| | | | | micron secondary |
| | | | | crystallization |
| Q | A | 72 + 72 | 1100-1300 | Possible Y diminishment of |
| | | quench | | contact refractory with trace |
| | | | | secondary crystallization |
| R | A | 72 | 1100-1300 | No reaction detected |
| R | A | 72 | 1100-1300 | No reaction detected |
| R | A | 72 + 72 | 1100-1300 | No reaction detected |
| | | quench | | |
| R | A | 72 + 72 | 1100-1300 | No reaction detected |
| | | quench | | |
| S | A | 72 | 1100-1300 | No reaction detected |
| S | A | 72 | 1100-1300 | No reaction detected |
| S | A | 72 + 72 | 1100-1300 | Morphology suggests |
| | | quench | | secondary crystallization |
| S | A | 72 + 72 | 1100-1300 | No reaction detected |
| | | quench | | |
| T | A | 72 | 1100-1300 | 211 micron layer of secondary |
| | | | | YPO₄ with spalling of layer |
| | | | | observed |
| T | A | 72 | 1100-1300 | 223 micron layer of secondary |
| | | | | YPO₄ with spalling of layer |
| | | | | observed |
| T | A | 72 + 72 | 1100-1300 | 300 micron layer of secondary |
| | | quench | | YPO₄ with spalling of layer |
| | | | | observed |
| P | J | 72 | 1200-1400 | No reaction detected |
| P | J | 72 | 1200-1400 | No reaction detected |
| P | J | 72 + 72 | 1200-1400 | Secondary LaPO₄ exists up to |
| | | quench | | 75 microns from refractory |
| | | | | interface |
| P | J | 72 + 72 | 1200-1400 | No reaction detected |
| | | quench | | |
| P | J | 72 + 72 | 1200-1400 | No reaction detected |
| | | quench | | |
| Q | J | 72 | 1200-1400 | Possible Y diminishment of |
| | | | | contact refractory |
| Q | J | 72 | 1200-1400 | No reaction detected |
| Q | J | 72 + 72 | 1200-1400 | Secondary LaPO₄ exists up to |
| | | quench | | 120 microns from refractory |
| | | | | interface |
| Q | J | 72 + 72 | 1200-1400 | Possible Y diminishment of |
| | | quench | | contact refractory with trace |
| | | | | secondary crystallization |
| Q | J | 72 + 72 | 1200-1400 | Y diminishment of contact |
| | | quench | | refractory |
| R | J | 72 | 1200-1400 | No reaction detected |
| R | J | 72 | 1200-1400 | No reaction detected |
| R | J | 72 + 72 | 1200-1400 | Secondary (La,Nd)PO₄ exists |
| | | quench | | up to 75 microns from |
| | | | | refractory interface |
| R | J | 72 + 72 | 1200-1400 | No reaction detected |
| | | quench | | |
| R | J | 72 + 72 | 1200-1400 | No reaction detected |
| | | quench | | |
| S | J | 72 | 1200-1400 | No reaction detected |
| S | J | 72 | 1200-1400 | No reaction detected |
| S | J | 72 + 72 | 1200-1400 | Secondary (La,Nd)PO₄ exists |
| | | quench | | up to 175 microns from |
| | | | | refractory interface |
| S | J | 72 + 72 | 1200-1400 | No reaction detected |
| | | quench | | |
| S | J | 72 + 72 | 1200-1400 | No reaction detected |
| | | quench | | |
| T | J | 72 | 1200-1400 | 1290 micron layer of |
| | | | | altered/recrystallized YPO₄, |
| | | | | 535 microns of which appears |
| | | | | more porous |
| T | J | 72 | 1200-1400 | No reaction detected |
| T | J | 72 + 72 | 1200-1400 | Recrystallization/alteration of |
| | | quench | | nearly the entire refractory and |
| | | | | secondary YPO₄ exists up to |
| | | | | 115 microns away from the |
| | | | | refractory interface |
| P | K | 72 + 72 | 1200-1400 | No reaction detected |
| | | quench | | |
| P | K | 72 + 72 | 1200-1400 | Trace secondary crystallization |
| | | quench | | of less than 10 microns |
| Q | K | 72 + 72 | 1200-1400 | No reaction detected |
| | | quench | | |
| Q | K | 72 + 72 | 1200-1400 | Trace secondary crystallization |
| | | quench | | of less than 10 microns |

As shown in Table 11, compositions of monazite with less Y and Nd reacted less with the test glasses at higher temperatures. The xenotime sample T, with 8% excess RE/P ratio Y₂O₃, did not have as relatively good performance with these glasses at high temperature as compared to the other tested samples.

### Creep Rate

Creep is an important material property for high temperature structural applications, such as its use as a refractory in the furnace or turbine blade. For refractory applications, low creep zircon (LCZ) has previously been employed, as it shows reasonable creep rates. In a comparative example, low creep zircon was purchased from St. Gobian. Creep bars with dimension of 0.197×0.118×6.5 inch³ or 0.197×0.118×8.5 inch were tested in three point flexure with an outer span of 6 or 8 inches. Steady state creep in flexure at 1,000 psi and 1179° C. and 1291° C. was measured and found to obey the following equation:

creep rate=10²⁰×e^{(-89,120/T)},

where T is temperature (Kelvin, K) and creep rate is in units of 1/hr.

In another comparative example, YPO₄ (xenotime) steady state creep rate was measured. The YPO₄ was made via solid state reaction, the powder milled, cold iso-statically pressed into bars and sintered at 1750° C. for 4-100 hours. Creep bars of 0.197×0.118×6.5 inch were machined. The bars were tested in three point flexure with an outer span of 6 inches. Steady state creep in flexure at 1,000 psi stress and 1180° C. and 1250° C. was measured. The creep rate was less than half that measured for the LCZ material. The creep rate obeyed the equation:

creep rate=2×10¹⁶×e^{(-79,370/T)},

where T is temperature (K) and creep rate is in units of 1/hr.

In a prophetic example, two monazite compositions, LaPO₄ and La_{0.82}Ce_{0.20}PO₄, were selected for testing high temperature creep properties, i.e. temperatures above 1180° C. The samples for testing creep were prepared via solid state reaction. An appropriate amount of starting materials were mixed, reacted, milled, and cold iso-statically pressed into bars. Pressed bar samples were sintered between 1600° C. and 1750° C. for 4-100 hours. Sintered bars were machined to 0.197×0.118×6.5 inch or 0.197×0.118×8.5 inch.

These prophetic machined bar samples were tested in three point flexural test machine with an outer span of 6 or 8 inches. Steady state creep in flexure at 1,000 psi stress was applied at different temperatures of 1180° C., 1250° C. and 1290° C. It was observed that overall creep rates for monazite compositions are less than those for low creep materials, including low creep zircon, such as two times less, three times less, or ten times less than previously employed low creep zircon.

In one example, monazite compositions showed a prophetic creep rate less than half of the creep rate of the low creep zircon at or above 1180° C., where the creep rate of the low creep zircon follows:

creep rate=10²⁰×e^{(-89,120/T)},

where T is temperature (K) (T≧1180° C. (1453 K) preferred) and creep rate is in the unit of 1/hr.

In another example, monazite compositions showed a prophetic creep rate less than one third of the creep rate of the low creep zircon at or above 1180° C. (1453 K). In yet another example, monazite compositions demonstrated a prophetic creep rate less than one tenth of the creep rate of the low creep zircon, according to equations (1), (2), and (3) below.

creep rate=0.5×10²⁰×e^{(-89,120/T)} (1)

creep rate=0.333×10²⁰×e^{(-89,120/T)} (2)

creep rate=0.1×10²⁰×e^{(-89,120/T)} (3)

where T is the temperature (K) and T≧1453 K and creep rate has units of 1/hr when measured in flexure at 1,000 psi.

While the embodiments in this disclosure are described for the refractories comprising greater than 90 mol % monazite, the disclosure is not limited by the examples in this disclosure. For example, the refractories for the outer layer of the forming device can comprise at least 50 volume percent of the monazite. In another instance, the refractories for the outer layer of the forming device can comprise at least 70 volume percent of the monazite. In yet another instance, the refractories for the outer layer of the forming device can comprise at least 90 volume percent of the monazite. It is understood that 90 mol % monazite does not always correspond to 90 volume percent monazite. For example, from SEM areal analysis, 90 mol % monazite can correspond to approximately 92 volume percent monazite.

While the refractories in this disclosure are based on monazite crystals, in another embodiment it is also possible that the monazite refractories for the outer layer of the forming device comprise xenotime type material. While xenotime type materials comprise rare earth phosphate, similar to monazite, xenotime type materials have different crystal structure than the monazite. The non-limiting examples of xenotime type materials include LaPO₄, CePO₄, PrPO₄, NdPO₄, SmPO₄, EuPO₄, GdPO₄, TbPO₄, DyPO₄, HoPO₄, ErPO₄, TmPO₄, YbPO₄, LuPO₄, YPO₄ or combinations thereof. For instance, a refractory may comprise 50 volume percent of monazite and 50 volume percent of xenotime. As described in sample preparation, reacted monazite crystals such as LaPO₄ can be mixed with reacted xenotime crystals such as YPO₄. The mixture can be pressed and sintered at high temperature for further densification. The composition balance of monazite and xenotime may be adjusted before sintering step. In another instance, a refractory can comprise at least 70 volume percent of monazite, such as from 70 to 99 volume percent of monazite, and up to 30 volume percent of xenotime, such as from 1 to 30 volume percent of xenotime. In yet another instance, a refractory can comprise at least 90 volume percent of monazite, such as from 90 to 99 volume percent of monazite, and up to 10 volume percent of xenotime, such as from 1 to 10 volume percent of xenotime.

The refractory may also consist essentially of monazite. For example, the refractory may consist essentially of single phase monazite.

The refractory may also comprise at least 50 volume percent of monazite, such as greater than 90 volume percent of monazite while comprising less than 10 volume percent of either zircon or xenotime, such as greater than 95 volume percent of monazite and less than 5 volume percent of either zircon or xenotime. In certain exemplary embodiments, the refractory may comprise less than 2 volume percent of at least one of zircon and xenotime, such as less than 2 volume percent of either zircon or xenotime, including less than 1 volume percent of at least one of zircon and xenotime, such as less than 1 volume percent of either zircon or xenotime. In certain exemplary embodiments, the refractory may be essentially free of at least one of zircon and xenotime, including essentially free of either zircon or xenotime. For example, the refractory may comprise at least 99 volume percent of monazite while comprising less than 1 volume percent of zircon and xenotime.

The refractory for the outer layer of the forming device can comprise at least one monazite and zircon. For example, reacted zircon powder may be mixed with monazite crystals. The mixture can be pressed and sintered to form a refractory. The composition of the refractory can be adjusted by initially adjusting the volume percent of zircon and the monazite crystals. The monazite can comprise at least 5 volume percent of the refractory. In another instance, the monazite can comprise at least 10 volume percent of the refractory. In yet another instance, the monazite can comprise at least 20 volume percent of the refractory.

In another embodiment, the refractory can comprise monazite, xenotime and zircon. As described above, desired volume percent of each material can be calculated to mix each monazite, xenotime and zircon in an appropriate amount. The mixed materials can be pressed and sintered at elevated temperature to form a refractory. The refractory can comprise at least 50 volume percent of the monazite. Xenotime and zircon can comprise the remaining volume percent of the refractory. In another instance, the refractory can comprise at least 70 volume percent of the monazite. Xenotime and zircon can comprise the remaining volume percent of the refractory. In yet another instance, the refractory can comprise at least 90 volume percent of the monazite. Xenotime and zircon can comprise the remaining volume percent of the refractory.

The refractories comprising monazite and at least one of xenotime and zircon can be used at least as one of a portion of the refractory for the forming device or a portion of the containment wall of the melting furnace that can support a predetermined quantity of molten glass before forming a glass sheet. The refractories can also be used as at least a portion of the inner layer of the containment wall of the melting furnace for melting glass batches or supporting molten glass. In case the refractory is used as the inner layer of the melting furnace, the refractory can comprise at least 50 volume percent of monazite. In another instance, the refractory can comprise at least 70 volume percent of monazite. In yet another instance, the refractory can comprise at least 90 volume percent of monazite.

It will be apparent to those skilled in the art that various modifications and variations can be made without departing from the spirit and scope of the claims.

What is claimed is:

1. A glass forming apparatus comprising a forming device configured to form a glass ribbon from a quantity of molten glass, wherein the glass forming apparatus comprises a refractory material comprising monazite (REPO4).

2. The glass forming apparatus of claim 1, wherein the forming device comprises the refractory material.

3. The glass forming apparatus of claim 2, wherein the refractory material comprises an outer layer of the forming device.

4. The glass forming apparatus of claim 1, further comprising a melting furnace configured to melt a quantity of material into the quantity of molten glass, wherein a containment wall of the melting furnace comprises the refractory material.

5. The glass forming apparatus of claim 4, wherein the refractory material comprises an inner layer of the containment wall that at least partially defines a containment area of the melting furnace.

6. The glass forming apparatus of claim 1, wherein the refractory material comprises at least 50 volume percent of monazite (REPO4).

7. The glass forming apparatus of claim 6, wherein the refractory material comprises at least 75 volume percent of monazite (REPO4).

8. The glass forming apparatus of claim 7, wherein the refractory material comprises at least 90 volume percent of monazite (REPO4).

9. The glass forming apparatus of claim 1, wherein the refractory material further comprises zircon (ZrSiO4).

10. The glass forming apparatus of claim 1, wherein the refractory material further comprises a xenotime type material.

11. The glass forming apparatus of claim 10, wherein the xenotime type material comprises at least one element selected from the group consisting of: La, Ce, Pr, Nd, Sm, Eu, Gd, Tb, Dy, Ho, Er, Tm, Yb, Lu, Y and Sc.

12. The glass forming apparatus of claim 1, wherein RE comprises at least one element selected from the group consisting of: La, Ce, Pr, Nd, Sm, Eu, Gd, Tb, Dy, Ho, Er, Tm, Yb, Lu, Y and Sc.

13. The glass forming apparatus of claim 12, wherein RE is a mixture of rare earth elements comprising La and at least one additional element selected from the group consisting of: Ce, Nd and Pr.

14. The glass forming apparatus of claim 12, wherein RE comprises at least 40 mole percent of La.

15. The glass forming apparatus of claim 12, wherein RE comprises at least 70 mole percent of La.

16. The glass forming apparatus of claim 1, wherein 0.95≦RE/P≦1.05.

17. The glass forming apparatus of claim 1, wherein an average grain size of the monazite is greater than 5 microns and less than 200 microns.

18. The glass forming apparatus of claim 1, wherein the refractory material comprises a creep rate of less than the rate described by the equation: creep rate=0.5×10²⁰×e^{(-89,120/T)}, where T is temperature (K) and T≧1453 K and creep rate is in unit of 1/hr when measured in flexure at 1,000 psi.

19. The glass forming apparatus of claim 1, wherein the refractory material comprises a creep rate of less than the rate described by the equation: creep rate=0.333×10²⁰×e^{(-89,120/T)}, where T is temperature (K) and T≧1453 K and creep rate is in unit of 1/hr when measured in flexure at 1,000 psi.

20. The glass forming apparatus of claim 1, wherein the refractory material comprises a creep rate of less than the rate described by the equation: creep rate=0.1×10²⁰×e^{(-89,120/T)}, where T is temperature (K) and T≧1453 K and creep rate is in unit of 1/hr when measured in flexure at 1,000 psi.

21. A method of forming a glass ribbon with a glass forming apparatus comprising the steps of:
supporting a quantity of molten glass with a refractory member comprising a refractory material comprising monazite (REPO4); and
forming the glass ribbon from the quantity of molten glass.

22. The method of claim 21, wherein the refractory member comprises at least one of a containment wall and a forming device of the glass forming apparatus.

23. The method of claim 21, wherein the refractory material comprises at least 50 volume percent of monazite (REPO4).

24. The glass forming apparatus of claim 1, wherein RE comprises at least 70 mole percent of La and at least one additional element selected from the group consisting of: Nd, Pr, and Y.

25. The glass forming apparatus of claim 24, wherein RE comprises Nd and Pr.
